(19) United States
(12) Patent Application Publication
(10) Pub. No.: US 2002/0153488 A1
(43) Pub. Date: Oct. 24, 2002

(54) Shadow based range and direction finder

(76) Inventors: Avanindra Utukuri, Mississauga (CA); Jonathan Douglas Clarke, North York (CA); Kumar Utukuri, Rockway, NJ (US)

Correspondence Address: KENYON & KENYON, 1500 K STREET, N.W., SUITE 700, WASHINGTON, DC, 20005, US

(21) Appl. No.: 10/091,558

(22) Filed: Mar. 7, 2002

Related U.S. Application Data
(63) Continuation-in-part of application No. PCT/US01/148224, filed on Oct. 30, 2001.
(60) Provisional application No. 60/274,312, filed on Mar. 8, 2001.
(60) Provisional application No. 60/276,292, filed on Mar. 16, 2001.

(51) Int. Cl. G01J 5/02

(52) U.S. Cl. 250/342

(57) ABSTRACT

Described is a manner of determining the three-dimensional direction of a radiating source. The system uses two pairs of coplanar solid-state radiation detectors perpendicularly arranged. The three-dimensional direction of the radiating source is found through the use of suitably positioned walls or absorbers of the radiation. The lengths of the shadows cast by the walls leads to a change in incident radiation detected by the various detectors. A ratio of the detected incident radiation is uniquely and simply related to the angle of the source in three dimensions. When the three-dimensional direction of the object is determined from two points, the distance to the object from each of the points is calculated using triangulation. A glove having one or more LEDs, uses the system to detect the three-dimensional position of each LED, and the three-dimensional positions of the LEDs are used to determine yaw, pitch and roll.

### RELATED APPLICATIONS

The present application is a Continuation-In-Part application of PCT application serial number PCT/US01/148224 “ELECTRONIC USER WORN INTERFACE DEVICE” filed on Oct. 30, 2001, the entire disclosure of which is incorporated herein by reference. The present application also claims the benefit of US provisional patent applications “SHADOW BASED RANGE AND DIRECTION FINDER”, serial No. 60/274,312, filed Mar. 8, 2001, and “GLOVE INTERFACE DEVICE”, serial No. 60/276,292, filed Mar. 16, 2001, the entire disclosures of which are incorporated herein by reference.

### BACKGROUND OF THE INVENTION

1. Field of Invention

The present invention relates generally to systems for detection of direction and distance of a radiating source. More specifically, the present invention is related to such a system that uses sets of coplanar detectors without the need for expensive optical components such as lenses or mirrors.

2. Discussion of Related Art

Detection and tracking of an object's direction and distance from a fixed point is desirable in a number of applications. One such application is for a three-dimensional computer input device. Computer applications, particularly in the gaming and design markets, have migrated from a two-dimensional visual interface to intuitive, real-world-simulating three-dimensional visual interfaces. Input devices, however, have been dominated by two-dimensional products such as mice, keyboards, joysticks and proprietary console controllers because of prohibitively high prices for three-dimensional input devices. The lack of tracking technology that is capable of being manufactured at low cost on a large scale is the cause of at least part of these device's prohibitive prices. An inexpensive system that can accurately measure and calculate how an object is positioned in space would go a long way in achieving a generally affordable three-dimensional input device for a computer system. For example, such a three-dimensional input device could be used to track a user's motions for input. In addition to computer input devices, there are a number of other consumer electronics applications that can benefit from a low cost detection and tracking system.

To date, however, there have not been any systems that detect and can track an object's direction and distance that are both accurate and low cost. Several recent systems are based on clusters of three or four detectors of incident radiation to detect the direction and distance of a point source of radiation. Some of them use lenses or other optical elements to concentrate the incident radiation. Such devices, while useful to detect sources at great distances, however, limit the angular range of detection severely. Some other schemes use mirrors positioned at specified angles to direct the radiation onto detectors, while other schemes use detectors located on inclined planes to achieve their directional sensitivity. These suffer from the requirement of additional optical components and their angular placement and the resultant costs and complexity. The three-dimensional placement of the detectors or mirrors also poses serious problems with change of reflectivity and detector sensitivity with angle.

### SUMMARY OF THE INVENTION

In one aspect of the present invention, a three-dimensional direction detector and corresponding method for detecting a three-dimensional direction of a radiating object is provided. The three-dimensional direction detector may include a first pair of planar detectors situated in the same plane that detect incident radiation from the radiating object and a second pair of planar detectors to detect incident radiation from the radiating object located proximate to, and in the same plane as, the first pair of detectors. The first pair of planar detectors may be bounded by at least one wall such that radiation from the radiating object incident at an angle with respect to the vertical along a first axis casts a shadow on one of the first pair of detectors and not the other. Similarly, the second pair of planar detectors may be bounded by at least one wall such that radiation from the radiating object incident at an angle with respect to the vertical along a second axis casts a shadow on one of the second pair of detectors and not the other, where the second axis is perpendicular to the first axis. A first two-dimensional direction of the radiating object in a plane defined by the first axis and the vertical is determined by a ratio of the detected incident radiation on each of the first pair of detectors. A second two-dimensional direction of the radiating object in a plane defined by the second axis and the vertical is determined by a ratio of the detected incident radiation on each of the second pair of detectors. The first and second two-dimensional directions are used to determine the three-dimensional direction of the radiating object.

In another aspect of the present invention, a system for detecting a three-dimensional position of a radiating object and corresponding method is provided. The system may include at least two three-dimensional direction detectors to detect the object's three-dimensional direction with respect to each direction detector, the direction detectors spaced a known distance apart along a baseline. Each of the direction detectors may include a first pair of planar detectors situated in the same plane that detect incident radiation from the radiating object and a second pair of planar detectors to detect incident radiation from the radiating object situated alongside and in the same plane as the first pair of detectors. The first pair of planar detectors may be bounded by at least one wall such that radiation from the radiating object incident at an angle with respect to the vertical along a first axis casts a shadow on one of the first pair of detectors and not the other. Similarly, the second pair of planar detectors may be bounded by at least one wall such that radiation from the radiating object incident at an angle with respect to the vertical along a second axis casts a shadow on one of the second pair of detectors and not the other, where the second axis is perpendicular to the first axis. Each three-dimensional direction detector is used to determine a three-dimensional direction of the radiating object. The object's three-dimensional direction is determined by a first two-dimensional direction of the radiating object in a plane defined by the first axis and the vertical that is determined from a ratio of the detected incident radiation on each of the first pair of detectors and a second two-dimensional direction of the radiating object in a plane defined by the second axis and the vertical that is determined from a ratio of the detected incident radiation on each of the second pair of detectors. The object's distance from each of the three-dimensional direction detectors is also determined using triangulation based on the object's three-dimensional directions detected by each of the three-dimensional direction detectors.

### BRIEF DESCRIPTION OF THE DRAWINGS

FIG. 1a conceptually illustrates a two-dimensional direction detector according to the principles of the present invention.

FIG. 1b illustrates a preferable construction of the detector arrangement conceptually illustrated in FIG. 1a.

FIG. 1c illustrates an embodiment in which there is a space between the filter and radiation detector.

FIG. 1d illustrates an aperture used to form horizontal walls.

FIG. 2 conceptually illustrates a three-dimensional direction detector formed from two of the detectors illustrated in FIG. 1a.

FIG. 3 illustrates angling the walls of a detector illustrated in FIG. 1a to prevent radiation reflected from the walls from falling on the planar detectors and causing erroneous measurements.

FIG. 4 illustrates an arrangement for detecting three-dimensional position of a radiating object using two three-dimensional direction detectors according to the principles of the present invention.

FIG. 5 illustrates how the three-dimensional position (i.e., x, y, z position) of the radiating source is determined once the three-dimensional directions (i.e., horizontal and vertical angles) are determined.

FIG. 6 illustrates a system that may be used with the present invention.

FIG. 7 illustrates a system that may be used with the present invention.

FIG. 8 illustrates circuitry that may be used with the present invention.

FIG. 9 illustrates the three main frames of reference considered to determine orientation when a detector according to the present invention is used to provide a three-dimensional input device.

FIG. 10 illustrates how a set of basis vectors is determined using three LEDs for calculating orientation.

### DESCRIPTION OF THE PREFERRED EMBODIMENTS

There is depicted in the drawings, and will herein be described in detail, one or more preferred embodiments of the invention, with the understanding that the present disclosure is to be considered as an exemplification of the principles of the invention and the associated functional specifications for its practice and is not intended to limit the invention to the embodiments illustrated. Those skilled in the art will envision many other possible variations within the scope of the present invention. The specific algorithms disclosed below represent an example of one method used to calculate range, direction, pitch, yaw and roll for the present invention. Equivalent calculations (achieving a functionally equivalent result) can be substituted without departing from the scope and content of the present invention descriptions.

The present invention provides detectors and methods to determine the three-dimensional direction of a radiating source. The source preferably radiates in the infrared range, however, other ranges of the electromagnetic spectrum, including visual light, are within the scope of the present invention. The system uses two pairs of coplanar solid-state radiation detectors perpendicularly arranged. The three-dimensional direction of the radiating source is found through the use of suitably positioned walls or absorbers of the radiation. The lengths of the shadows cast by the walls leads to a change in incident radiation detected by the various detectors. A ratio of the detected incident radiation is uniquely and simply related to the angle of the source in three dimensions.

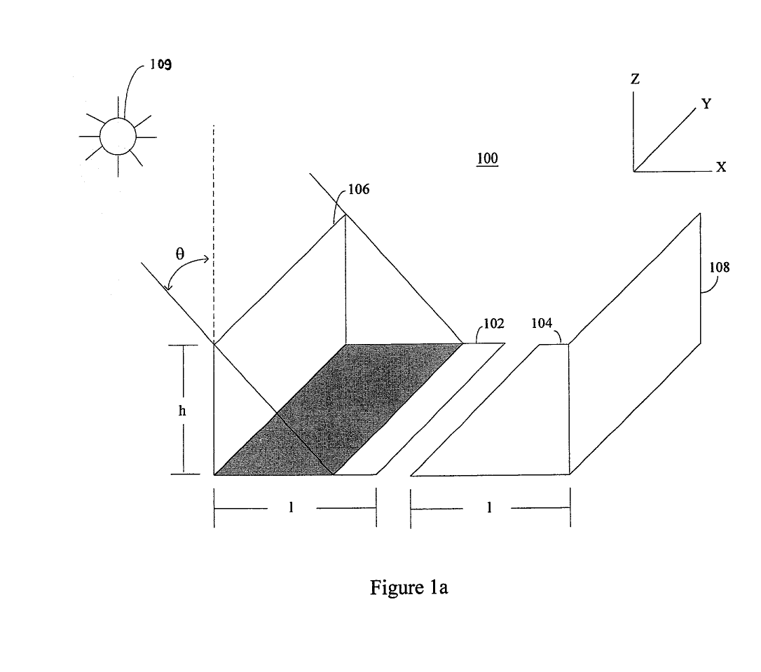

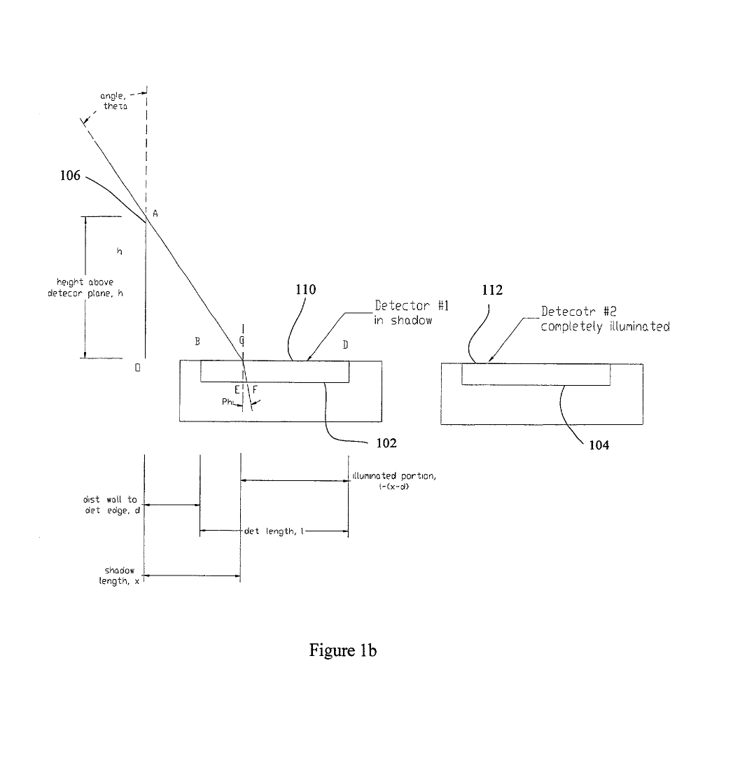

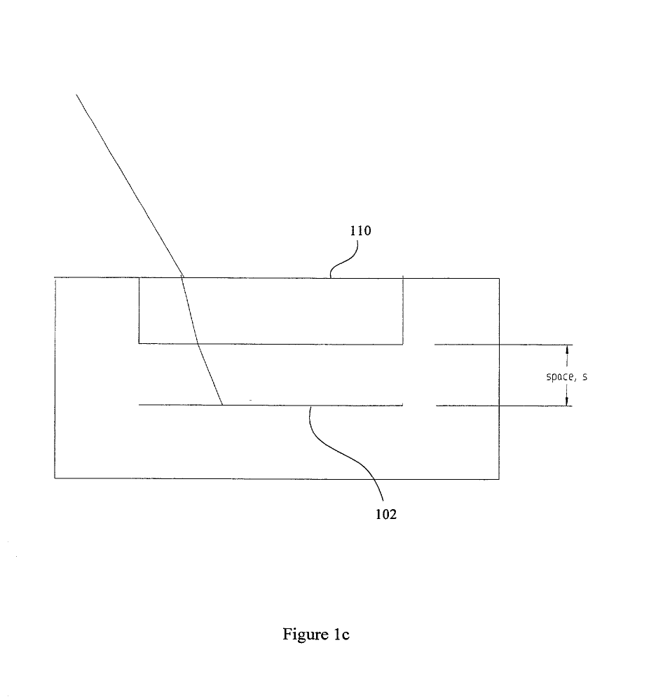

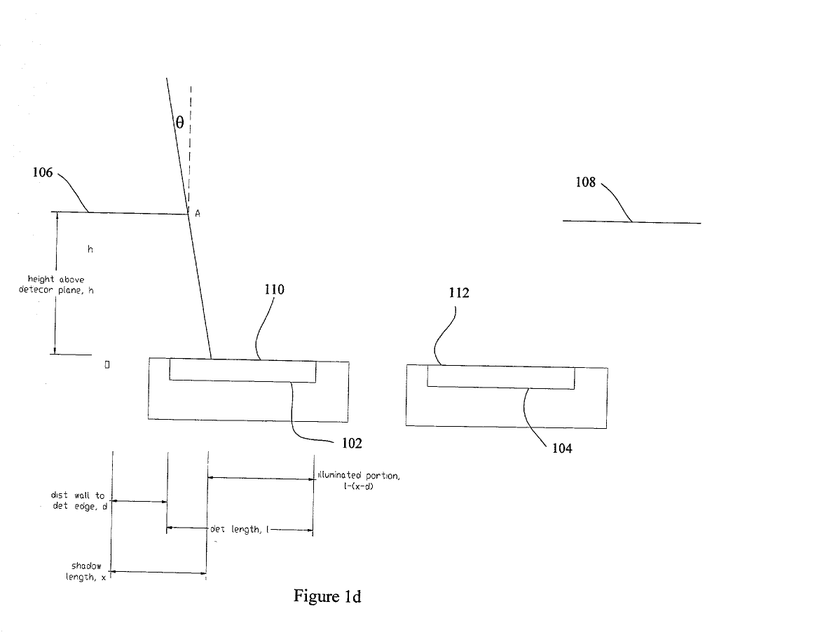

A single pair of planar detectors 100 arranged according to the principles of the present invention is conceptually illustrated in FIG. 1a. An x-y-z coordinate system is provided as shown to aid in the following discussion. The single pair 100 detects the incident angle θ, as shown, of radiation from a radiating source 109 (e.g., one or more infrared LEDs). The angle θ, as shown, is the angle with respect to the vertical along the x-axis, i.e. it is the direction of the radiating source in the x-z plane. Thus, the single pair of detectors determines a two-dimensional direction of the radiating source.

In this arrangement, a planar radiation detector 102 is situated in the same plane (x-y plane as illustrated) as a second, similar planar radiation detector 104. Detectors 102 and 104 may be rectangular detectors, with sides preferably of equal length, l.

Detector 102 is bounded on one side by a wall 106, impervious to the radiation. Similarly, detector 104 is bounded one the opposite side by a wall 108, also impervious to the radiation. Walls 106 and 108 preferably extend beyond the full width of the detectors. Extension beyond the full width of the detectors minimizes edge effects of any shadows. The height, h, of the walls are preferably equal to the length of each detector, l, but that does not have to be necessarily so. Thus, the radiation from a source casts a shadow on one detector and not the other. The radiation incident on detectors 102 and 104 is used to find the angle θ.

How the angle θ is found is described in conjunction with the construction of detector arrangement 100 illustrated in FIG. 1b. As illustrated, preferably, detectors 102 and 104 are separately packaged beneath filters 110 and 112. Filters 110 and 112 are preferably used to reject ambient room light, and only pass radiation in the spectrum transmitted by radiating source 109, e.g. the infrared spectrum, to provide a better signal. Separately packaged detectors are preferably used as they are commercially available at economical prices, however, the detectors do not have to be separately packaged. Wall 106, of height h, is placed a distance d away from the edge of detector 102. While not shown for clarity of the following explanation, wall 108, however, is similarly configured a distance d away from detector 104. As described before, detectors 102 and 104 have a length l. When the radiation source makes an angle θ in the negative x direction as shown in FIG. 1a, the wall casts a shadow of length x as shown. While detector 104 is completely illuminated, the shadow covers a length x−d of detector 102, which leaves a portion of length l−(x−d) illuminated. In terms of the θ, the shadowed portion has length:

h tan θ−d

making the illuminated length:

l−(h tan θ−d).

As previously described, the radiation incident on detectors 102 and 104 is used to find the angle θ. The amounts of incident radiation are given by:

I₁=kw(l−h tan θ+d)

I₂=klw

where I₁ is the amount of incident radiation on detector 102, I₂ is the amount of incident radiation on detector 104, w is the width of the detectors and k is a proportionality factor that includes detector sensitivity, system gain, etc. It is assumed to be the same for both detectors. Note that if the detectors are square, w is equal to l.

Taking the ratio of the incident radiation:

$${I}_{1} / {I}_{2} = 1 - \frac{( h tan θ - d )}{l}$$

So,

θ=arctan[(lR+d)/h],

where R is:

R=(I₂−I₁)/I₂.

Conversely, when the radiation source makes an angle θ in the positive x direction, R is given

R=(I₂−I₁)/I₁

Combining these results, therefore, the angle θ with respect to the vertical along the x-axis is calculated by:

θ=arctan[(lR+d)/h],

where R is:

R=[(I₂−I₁)/(larger of I₁ & I₂)].

This expression provides both the magnitude and sign of the angle with respect to the vertical. A negative calculation of θ indicates the source is in the negative x direction, while a positive calculation indicates the source is in the positive x direction.

This expression also assumes that the detector is right at the surface of the package. However, when it is not, refraction in the filter requires a correction. From FIG. 1b, it can be seen that the shadow is lengthened when there is a filter. If the filter is bonded to the detector, then the extra shadow length, EF, is:

EF=t tan φ

where t is the thickness of the filter, and where n is its refractive index:

Sin θ=n sin φ

For small values of θ and φ, one can write sin θ=tan θ and sin φ=tan φ, then:

EF=t tan θ/n

This approximation is made only for simplifying the formulae. However, this approximation does not have to be made, and is not a critical portion of the invention.

So, the illuminated area is:

$$l w - w ( h tan θ - \frac{t tan θ}{n} - d )$$

because the part in parenthesis is the percentage of the detector that is shadowed. This can be rewritten as:

$$w ( 1 - tan θ ( h + \frac{t}{n} ) + d )$$

i.e. h is replaced by (h+t/n).

So, the solution becomes:

$$θ = arctan [ ( l R + d ) / ( h + \frac{t}{n} ) ] ,$$

where R is:

R=[(I₂−I₁)/(larger of I₁ & I₂)].

In alternate designs, the filter may not be bonded to the detector such that there is an air/vacuum spacing of ‘s’ between. This is illustrated in FIG. 1c. In this case, the formula becomes:

$$θ = arctan [ ( l R + d ) / ( h + \frac{t}{n} + s ) ]$$

While walls 106 and 108 have been illustrated as separate, vertical walls, i.e. perpendicular to the plane of detectors 102 and 104, this is not necessary. For instance, an aperture (e.g., a square or rectangular hole placed above detectors 106 and 108) can be used to form horizontal walls, which result a radiating source casting a shadow on one detector and not the other, as shown in FIG. 1d.

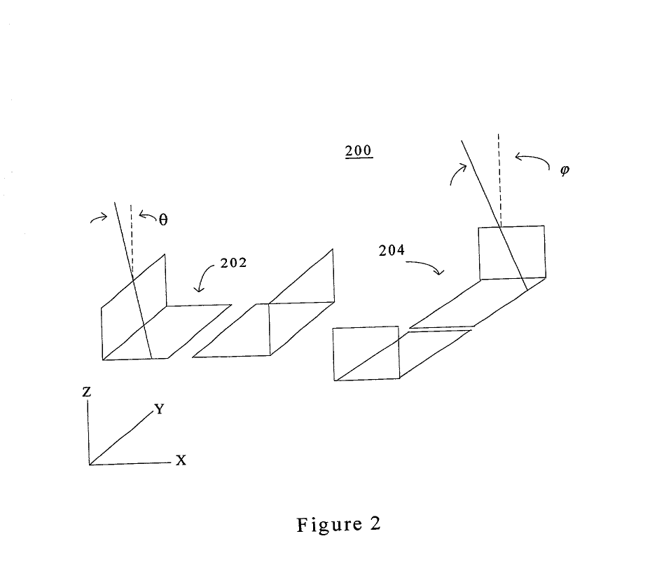

A second pair of detectors arranged perpendicularly would detect the incident angle of radiation with respect to the vertical along the y-axis. This arrangement provides for a three-dimensional direction detector. A three-dimensional direction detector 200 formed by this arrangement is illustrated in FIG. 2. As shown, a first pair of detectors 202 is arranged as described in FIG. 1a. A second pair of detectors 204 is placed alongside the pair 202, but oriented perpendicular thereto. The first pair 202 provides the incident angle θ with respect to the vertical along the x-axis, as previously described. This angle describes the direction of the radiating source in the x-z plane. In a similar fashion, the second pair 204 provides the incident angle φ with respect to the vertical along the y-axis because of its perpendicular orientation. This angle describes the direction of the radiating source in the y-z plane. Because any direction in three-dimensional space can be broken into a component in the x-z plane and a component in the y-z plane, the angles θ and φ provide the three-dimensional direction of the radiating source. It should be noted that, in arranging the pairs of detectors 202 and 204, care should be taken to ensure that the walls used for θ determination do not cast shadows on the detectors used for φ determination and vice versa.

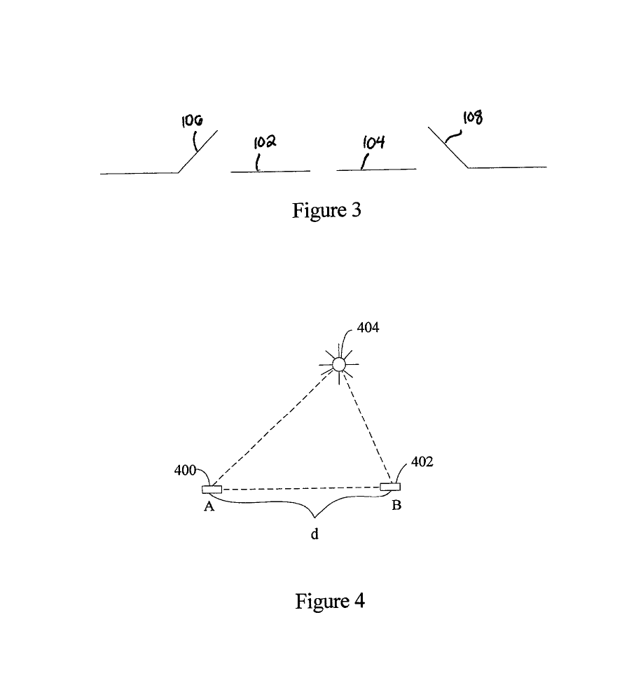

By angling the walls as shown in FIG. 3, radiation reflected from the walls is prevented from falling on the detectors. In addition, by changing the ratio of wall height to detector length, different angular ranges and sensitivities are obtained. Also, using different sizes of detectors for either the positive or negative angles achieves a larger angular range for one than the other. For instance, if detector 102 in FIG. 1 is larger than detector 104, a larger angular range is achieved for negative angles of θ than for positive angles. Simple modifications of the formulae given above would suffice to provide the proper angles in cases where the detectors are made to be of dissimilar size as suggested above.

The present invention has a number of advantages:

The incident radiation is not restricted by an aperture and one of the planar detectors is always fully illuminated. On a relative scale, the individual signals from each planar detector “range” from 1 (at head on) to zero, and the total signal resulting from the four planar detectors ranges from 4 (at head on) to 2.

A large fraction of the detector area is always illuminated providing much larger usable ranges than previous systems.

One detector for each direction is fully illuminated at all angles and its signal provides normalization.

The detectors are arranged on the same plane, which minimizes mounting difficulties and expenses. In addition, there is not a need for accurately aligned angular positioning of the detectors.

Any detector element including inexpensive solar cells could be utilized.

Expensive optical elements, such as mirrors or lenses, are not needed.

The planar detectors do not have to be arranged in very close proximity to each other as is required with a central aperture. Therefore, inexpensive, single planar detectors can be used rather than expensive, segmented planar detectors.

Light strikes both detectors of a single axis pair at the same angle. Thus, any deviation from Lambertian behavior affects both of them in the same way. Because of this, and the fact that only incident radiation ratios are used for the calculations, the accuracy of the measurement is not altered by the incident angle.

By using a second three-dimensional direction detector placed a known distance away from a first three-dimensional direction detector, the complete three-dimensional position of the radiating source can be calculated. This arrangement is illustrated in FIG. 4. A three-dimensional direction detector 400 constructed as shown in FIG. 2 is placed at a point A. A second similar detector 402 is placed at a point B. Points A and B are separated by a known distance, d, along what is normally called a baseline. Detector 400 measures the three-dimensional direction of a radiating object 404 from point A in the manner previously described. Likewise, detector 402 measures the three-dimensional direction of radiating object 404 from point B. Once both the directions are determined, triangulation is used to calculate the distance of the object from either point A or B. Thus, the complete three-dimensional position of radiating source 400 is calculated from the arrangement shown, i.e. the distance and three-dimensional direction of the radiating object from either detector is measured.

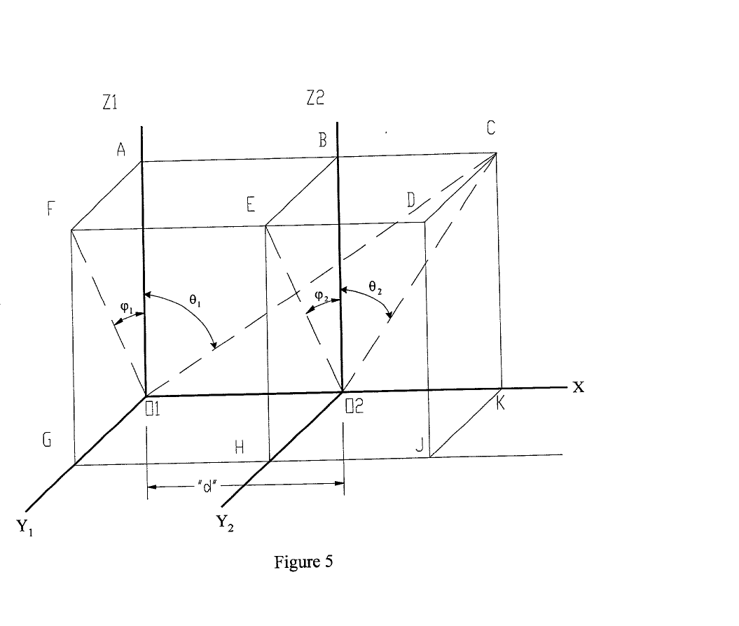

FIG. 5 illustrates how the three dimensional position (i.e., x, y, z position) of the radiating source is determined once the three-dimensional directions (i.e., horizontal and vertical angles) are determined from detectors 400 and 402.

In FIG. 5, O₁ and O₂ represent the two detectors 400 and 402, which are located on a common X-axis (baseline). Y₁ and Y₂ are the two Y-axes, while Z₁ and Z₂ are the two Z-axes. D is the position of the radiating object.

The projection of the object's position in the XZ₁ plane is O₁C subtending the angle θ₁ with respect to the Z₁ axis, which is the angle θ detected by detector 400. The projection in the Y₁Z₁ plane is O₁F subtending an angle φ₁, which is the angle φ detected by detector 400. The corresponding angles from the second detector 402 at O₂ are θ₂ and φ₂. Since detectors 400 and 402 are displaced only along the X axis, φ₁=φ₂, Y₁=Y₂=Y and Z₁=Z₂=Z

So,

Z=Z₁=Z₂=O₁A=O₂B, common to both

X₁=O₁K=AC=Z tan θ₁

X₂=O₂K=BC=Z tan θ₂

X₁=X₂+d

Therefore:

Z=d/(tan θ₁−tan θ₂).

And

X₁=d/(tan θ₁−tan θ₂)*tan θ₁

X₂=d/(tan θ₁−tan θ₂)*tan θ₂

And

Y₁=O₁G=AF=Z tan φ₁==Y₁=O₂H=BE=Z tan φ₂

Y₁=Y₂=Y=d/(tan θ₁−tan θ₂)*tan φ₂

Using the above, the three-dimensional position of the radiating object with respect to either detector 400 or 402 can be calculated. The formulas are exact and provide the correct sign + or −. For the above formulas, it is possible to obtained the tan of the angle directly from detectors 400 and 402, thereby alleviating the need to recalculate it. In addition, the specific algorithms above and continued below, represent one possible implementation of the calculations necessary to determine the three dimensional position and pitch, yaw and roll. Equivalent calculations (achieving a functionally equivalent result) can be substituted without departing from the scope and content of the present invention descriptions.

In an additional embodiment, the radiation from the source is modulated and detection is done at the modulation frequency only. This provides for discrimination from ambient radiation. In addition, this technique provides the ability to measure position information for several sources. The signals from different sources are made distinguishable using any modulation technique such as FDM, TDM, PCM, etc. Through suitable decoding at the detector end the positions of all the sources are then found at the same time. Thus, the system can be easily extended for simultaneous detection of several radiating sources, the number of sources being limited only by data processing speeds and capacities.

All of the calculations described herein may be done by circuitry connected to the detectors. The circuitry may be of any type that can receive incident radiation from the detectors and make the necessary calculations. Those of ordinary skill in the art could design numerous different types of circuitry to perform these calculations, all of which would be within the scope of the present invention. Such circuitry could include microprocessors or micro-controllers programmed to carry out the calculations described herein, as well as other associated circuitry, for example.

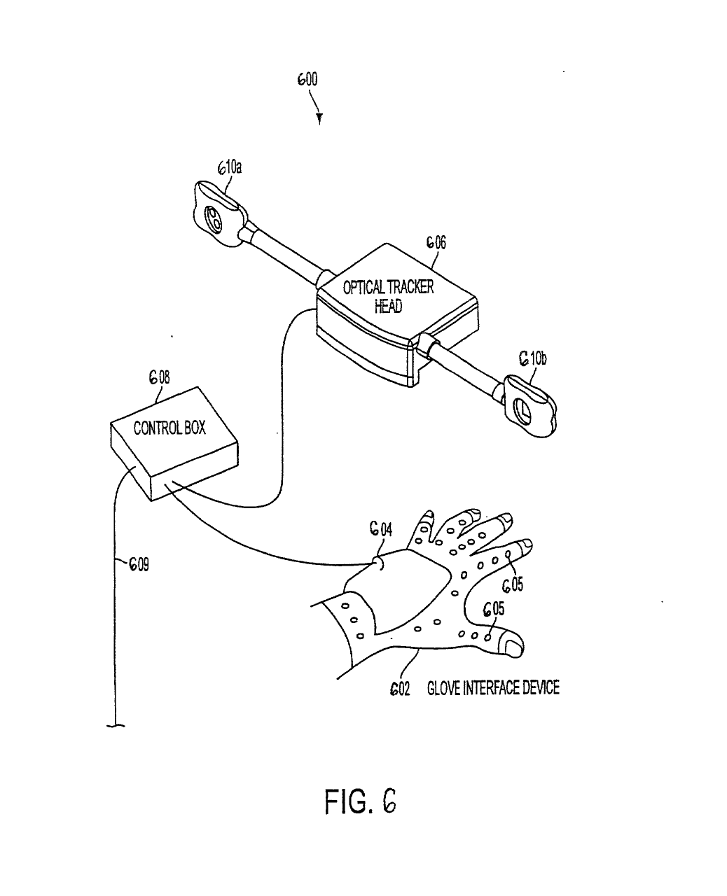

FIG. 6 illustrates a specific use of the detectors of the present invention, which is described in detail in co-pending parent application serial number PCT/US01/148224. The system 600 includes a glove 602 with embedded electronics 604, sources of radiation 605 (LEDs), optical tracker 606, and circuitry, which may be housed in control box 608. The optical tracker 606 may include tracker heads 610a and 610b, which may have detectors and associated walls disposed therein, such as the detectors and walls disclosed in FIGS. 1-4. The circuitry in control box 608 can perform the above-described calculations. Alternatively, some portion of the circuitry may be disposed in the glove 602 or other user worn device.

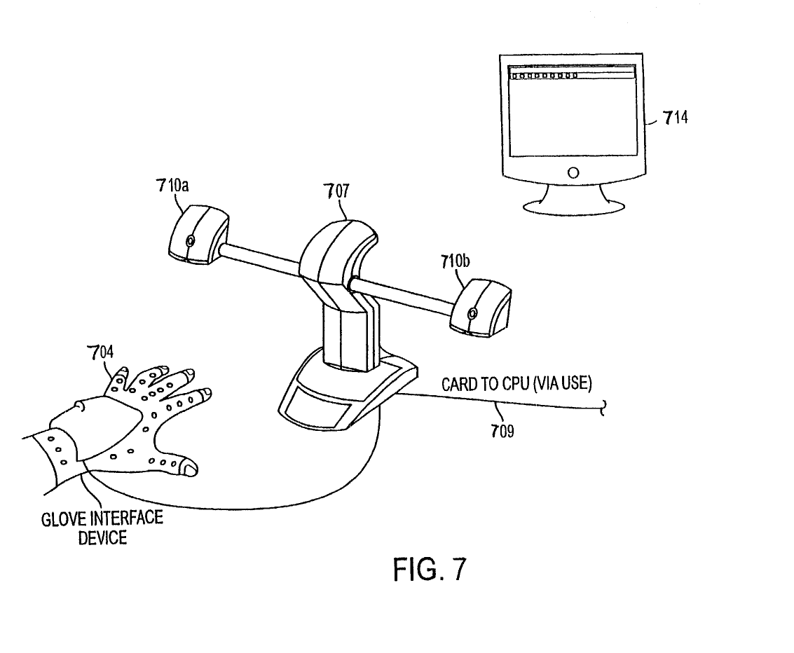

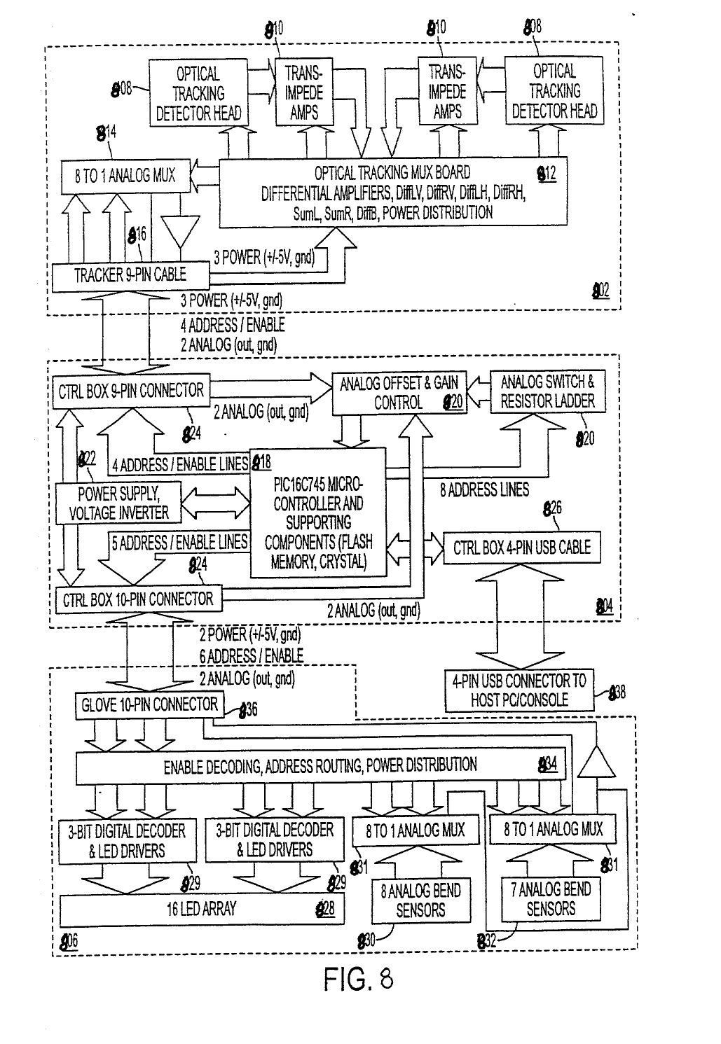

FIG. 7 illustrates another specific use of the detectors of the present invention, which is also described in detail in co-pending parent application serial number PCT/US01/148224. In this embodiment, the control box 608 and optical tracker 606 have been combined in a single integrated station 707, which can include some or all of the circuitry described above. Monitor 714 from a connected PC or other computer or gaming system can display the data input by the user movement of glove 704. Further, the detectors may be attachable in various locations, such as on a monitor, laptop, glare screen, vest, necklace, computer furniture, consoles, walls, enclosures, computer cases, detachable ibars, etc.

FIG. 8 illustrates circuitry that could be used with the present invention. As shown, the system comprises the tracker circuitry 802, control box circuitry 804, and glove circuitry 806. The tracker circuitry includes a main section 812 including an optical tracking multiplexing board, differential amplifiers, DiffLV, DiffRV, DiffLH, DiffRH, SumL, SumR, DiffB, and power distribution, left and right tracking detector heads 808, output amps for the heads 810, associated signal transferring MUX 814, and connectors for cables 816. The tracking detector heads do not have to be right and left, but can be positioned in any spatial relationship.

The controller box 804 may include a micro-controller and supporting components such as flash memory, crystal for clock/timing, various analog control circuitry 820, power supply 822, and connectors 824 and USB 826 connection to a computer or electronic based device such as a PC or gaming console.

The glove circuitry 806 includes an LED array and associated decoders and drivers 829 analog bend sensors 830 and 832 and associated interfaces MUX's 831. The LEDs are driven to output light signals and the bend sensors return signals of movement (typically based on a strain (change of capacitance) of the electro-resistive strip sensors). The routing of signals is controlled through 834 and may be hardwired, programmable or preprogrammed by conventional means. Connector 836 provides I/O of signals to the controller 804. As indicated above, those of skill in the art could design various types of circuitry that would function to perform the calculations described herein.

The present invention can provide an inexpensive tracking system for use with a three-dimensional input device. A device, which may be a body wearable device, such as a glove to be worn by a user, is outfitted with LEDs that radiate, for example, in the infrared or visible ranges. The position of any type of device may also be detected by detecting the position of LEDs in such devices in accordance with the present invention. Some possible devices include a necklace, ankle bracelet, waist band, wands, handles for racquets, and a writing utensil, for example. The LEDs act as the radiating source that is detected by a position detection system as described in FIG. 4. In this way, when a glove is used, a user's hand position is detected and tracked for three-dimensional input. Also, the LED's are not critical and the invention can be used with any type of point source, such as a short filament lamp, etc. Further, the system can be used to determine yaw, pitch and roll of the user's hand, for example, when a glove is used. Thus, six degrees of freedom can be detected with the system.

To obtain the position and orientation of the user's hand, the system as illustrated in FIG. 4 first determines the three-dimensional position of all LEDs on the glove visible to the detectors using the techniques described above. This is performed, for example, by modulating each LED at a different frequency as described above. The position of the LEDs indicates the general position of the hand in space. Given the positional information of all the LEDs in space, the orientation of the entire hand can be calculated.

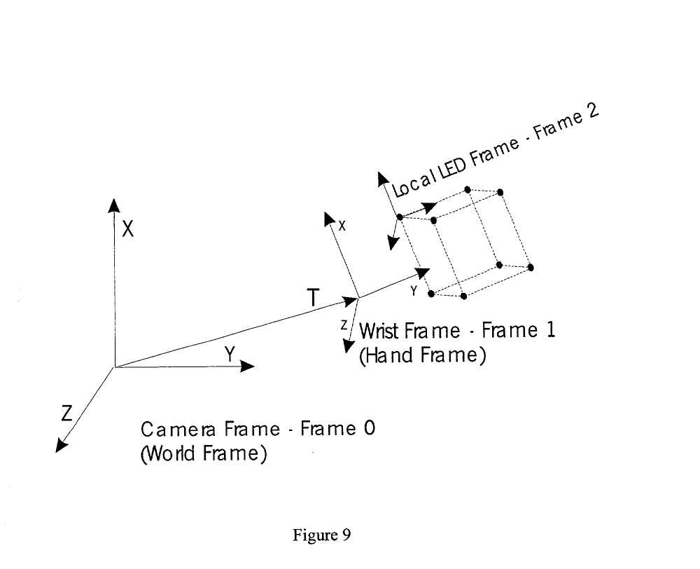

In determining the hand orientation, there are three main frames of reference that must be considered. These frames are illustrated in FIG. 9. The first frame is the frame of reference of the system of FIG. 4. This is the world co-ordinate frame (Frame 0), which will be referred to as the camera frame of reference. Then, there is another frame of reference, which is the hands or wrist frame of reference (Frame 1), in which all LEDs on the glove are placed in. Finally, another frame of reference using a specific group of 3 LEDs (Frame 2) is created. It should be noted that Frame 2 is constant with respect to Frame 1, and Frame 1 is moving with respect to Frame 0 as the user moves their hand in space. It should also be noted that the positional information obtained by the system of FIG. 4 is the x, y, z position information of all visible LEDs in the camera frame of reference.

Determining the orientation of the wrist frame with respect to the camera frame gives the hand orientation with respect to the camera frame (i.e., yaw, pitch and roll information). The yaw, pitch and roll of the wrist frame are determined from the specific rotation matrix to transform points between the camera frame and the wrist frame.

A rotation matrix describes the orientation of a second reference frame with respect to a first reference frame and transforms points in the first reference to points in the second reference frame. The columns of a rotation matrix form the basis vectors for the transformed space. Inversely, given a set of basis vectors (i, j, k) in an absolute world frame, a rotation matrix can be created that transforms points from the absolute world frame to the relative world frame defined by the basis vectors.

The following is an arbitrary rotation matrix R=R_{z, φ,}*R_{y, Θ}*R_{x, ψ}, where φ is the roll, Θ is the pitch and ψ is the yaw of a relative reference frame with respect to the absolute frame.

$$[ \begin{matrix}i & j & k \\ cos φcos Θ & - sin φcosψ + cos φsinΘ sin ψ & sin φsinψ + cos φsinΘ cos ψ \\ sin φcos Θ & cos φcosψ + sin φsinΘ sin ψ & - cos φsinψ + sin φsinΘcos ψ \\ - sin Θ & cos Θsin ψ & cos Θ cos ψ\end{matrix} ]$$

To determine the wrist frame orientation, the specific rotation matrix R_{0->1} (i.e., the rotation matrix from frame 0, camera frame, to frame 1, wrist frame) is calculated. R_{0->1} is calculated by:

R_{0->1}=R_{0->2}[R_{1->2}]^{t}

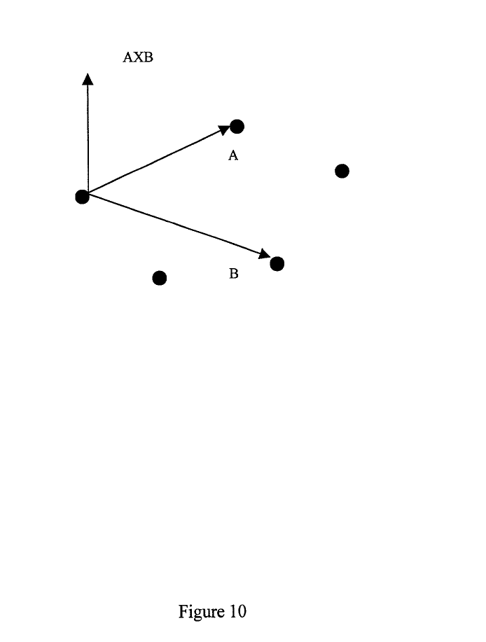

To obtain R_{0 ->2}, a basis set is created from the LEDs visible to the camera and used to create the rotation matrix. This is done as illustrated in FIG. 10. The positions of the LED's are an arbitrary set of 3D positions. In order to create a basis set given an arbitrary set of 3D positions, 2 vectors (A and B) are created using three LEDs. A basis set is then created from the set of basis vectors A, AxB and Ax(AxB). This basis set represents the frame 2 formed by the three LEDs. After normalizing these vectors as the i, j and k column vectors, a rotation matrix R_{0->2} is created. In the same manner, R_{1->2} can be calculated by measuring the physical geometry of the same three LEDs with respect to an origin on the hand.

Using these two matrices, R_{0->1} is calculated. After determining the R_{0->1} matrix, the actual angles of yaw, pitch and roll are calculated by setting the R_{0->1} matrix to equal the general yaw\pitch\roll (rotation) matrix described above. Solving for the angles.

That is:

Θ=sin⁻¹(−R_{0->1[3,1]})

ψ=tan⁻¹(R_{0->1[3,2]}/R_{0->1[3,3]})

φ=tan⁻¹(R_{0->1[2,1]}/R_{0->1[1,1]})

These are the pitch, yaw and roll of the wrist frame with respect to the camera frame, and, hence, the pitch, yaw and roll of the user's hand in the camera frame. The above equations are for the first quadrant. Other quadrants are found using a combination of the signs of the rotation matrix elements.

### CONCLUSION

A system and method has been shown in the above embodiments for the effective implementation of a shadow based range and direction finder. While various preferred embodiments have been shown and described, it will be understood that there is no intent to limit the invention by such disclosure, but rather, it is intended to cover all modifications and alternate constructions falling within the spirit and scope of the invention, as defined in the appended claims. Further, the uses described are only indicative of those possible and those skilled in the art could use the present invention in many other situations. In addition, the specific algorithms disclosed represent one possible implementation of the calculations necessary to detect an objects position and movement in space. Equivalent calculations (achieving a functionally equivalent result) can be substituted without departing from the scope and content of the present invention descriptions.

1. A system for detecting a three-dimensional direction of a radiating object comprising:
a first pair of planar detectors that detect incident radiation from the radiating object, the first pair of planar detectors situated in the same plane and bounded by at least one wall such that radiation from the radiating object incident at an angle with respect to the vertical along a first axis casts a shadow on one of the first pair of detectors and not the other;
a second pair of planar detectors to detect incident radiation from the radiating object, the second pair of detectors located proximate to, and in the same plane as, the first pair of detectors, the second pair of planar detectors bounded by at least one wall such that radiation from the radiating object incident at an angle with respect to the vertical along a second axis casts a shadow on one of the second pair of detectors and not the other, the second axis perpendicular to the first axis; and
circuitry connected to the first and second pair of planar detectors, the circuitry determining a first two-dimensional direction of the radiating object in a plane defined by the first axis and the vertical based on a ratio of the detected incident radiation on each of the first pair of detectors, determining a second two-dimensional direction of the radiating object in a plane defined by the second axis and the vertical based on a ratio of the detected incident radiation on each of the second pair of detectors, and determining the three-dimensional direction of the radiating object based on the first and second two-dimensional directions.

2. A system for detecting a three-dimensional direction of a radiating object, as per claim 1, wherein the radiating object radiates in the infrared range.

3. A system for detecting a three-dimensional direction of a radiating object, as per claim 1, wherein the radiation is modulated and the modulated radiation is detected.

4. A system for detecting a three-dimensional direction of a radiating object, as per claim 1, wherein the radiating object is one or more LEDs.

5. A system for detecting a three-dimensional direction of a radiating object, as per claim 4, wherein the one or more LEDs are mounted on a glove.

6. A system for detecting a three-dimensional position of a radiating object comprising:
at least two three-dimensional direction detectors to detect the object's three-dimensional direction with respect to each direction detector, the direction detectors spaced a known distance apart along a baseline, each of the direction detectors comprising a set of coplanar radiation detectors with at least one wall arranged such that shadows cast by the wall leads to a change in incident radiation from the radiating object detected by the radiation detectors, each of the radiation detectors detecting the radiation incident thereon; and
circuitry connected to the radiation detectors, the circuitry determining a first and a second two-dimensional direction from each set of coplanar radiation detectors to the radiating object based on a ratio of the detected incident radiation, determining the object's three-dimensional direction based on the determined first and second two-dimensional directions, and determining the object's distance from each of the three-dimensional direction detectors using triangulation based on the object's determined three-dimensional directions.

7. A system for detecting a three-dimensional position of a radiating object, as per claim 6, wherein the set of coplanar radiation detectors comprises:
a first pair of planar radiation detectors that detect incident radiation from the radiating object, the first pair of planar radiation detectors bounded by at least one wall such that radiation from the radiating object incident at an angle with respect to the vertical along a first axis casts a shadow on one of the first pair of detectors and not the other;
a second pair of planar detectors to detect incident radiation from the radiating object, the second pair of detectors, the second pair of planar detectors bounded by at least one wall such that radiation from the radiating object incident at an angle with respect to the vertical along a second axis casts a shadow on one of the second pair of detectors and not the other, the second axis perpendicular to the first axis;
wherein the first two-dimensional direction of the radiating object is in a plane defined by the first axis and the vertical and is determined based on a ratio of the detected incident radiation on each of the first pair of detectors; and
wherein the second two-dimensional direction of the radiating object is in a plane defined by the second axis and the vertical and is determined based on a ratio of the detected incident radiation on each of the second pair of detectors.

8. A system for detecting a three-dimensional position of a radiating object, as per claim 6, wherein the radiating object radiates in the infrared range.

9. A system for detecting a three-dimensional position of a radiating object, as per claim 6, wherein the radiation is modulated and the modulated radiation is detected.

10. A system for detecting a three-dimensional position of a radiating object, as per claim 6, wherein the radiating object is one or more LEDs.

11. A system for detecting a three-dimensional position of a radiating object, as per claim 10, wherein the one or more LEDs are mounted on a body worn device.

12. A system for detecting a three-dimensional position of a radiating object, as per claim 6, wherein the radiating object comprises a plurality of LEDs on a device to be worn by a user, the system detects the three-dimensional position of each LED, and the three-dimensional positions of the LEDs are used to determine yaw, pitch and roll of a user's associated body part.

13. A system for detecting a three-dimensional position of a radiating object, as per claim 12, wherein the yaw, pitch and roll are determined from a rotation matrix calculated based on the three-dimensional positions of three out of the plurality of LEDs.

14. A method of detecting a three-dimensional direction of a radiating object comprising:
providing a first pair of planar detectors that detect incident radiation from the radiating object, the first pair of planar detectors situated in the same plane and bounded by at least one wall such that radiation from the radiating object incident at an angle with respect to the vertical along a first axis casts a shadow on one of the first pair of detectors and not the other;
providing a second pair of planar detectors to detect incident radiation from the radiating object, the second pair of detectors situated alongside and in the same plane as the first pair of detectors, the second pair of planar detectors bounded by at least one wall such that radiation from the radiating object incident at an angle with respect to the vertical along a second axis casts a shadow on one of the second pair of detectors and not the other, the second axis perpendicular to the first axis;
calculating a first two-dimensional direction of the radiating object in a plane defined by the first axis and the vertical based on a ratio of detected incident radiation on each of the first pair of detectors;
calculating a second two-dimensional direction of the radiating object in a plane defined by the second axis and the vertical based on a ratio of detected incident radiation on each of the second pair of detectors; and
calculating the three-dimensional direction of the radiating object based on the calculated first and second two-dimensional directions.

15. A method of detecting a three-dimensional direction of a radiating object, as per claim 14, wherein the radiating object radiates in the infrared range.

16. A method of detecting a three-dimensional direction of a radiating object, as per claim 14, wherein the radiation is modulated and the modulated radiation is detected.

17. A method of detecting a three-dimensional direction of a radiating object, as per claim 14, wherein the radiating object is one or more LEDs.

18. A method of detecting a three-dimensional direction of a radiating object, as per claim 17, wherein the one or more LEDs are mounted on a glove.

19. A method of detecting a three-dimensional direction of a radiating object, as per claim 17, wherein the radiating object comprises a plurality of LEDs on a device to be worn by a user, the method further comprising determining the three-dimensional position of each LED, and determining the yaw, pitch and roll of a user's associated body part based on the determined three-dimensional position of each LED.

20. A method of detecting a three-dimensional direction of a radiating object, as per claim 19, further comprising determining the yaw, pitch and roll from a rotation matrix calculated based on the three-dimensional positions of three out of the plurality of LEDs.

21. A method of detecting a three-dimensional position of a radiating object comprising:
providing at least two three-dimensional direction detectors to detect the object's three-dimensional direction with respect to each direction detector, the direction detectors spaced a known distance apart along a baseline, each of the direction detectors comprising a set of coplanar radiation detectors with at least one wall arranged such that shadows cast by the wall leads to a change in incident radiation from the radiating object detected by the radiation detectors, each of the radiation detectors detecting the radiation incident thereon;
calculating a first and a second two-dimensional direction from each set of coplanar radiation detectors to the radiating object based on a ratio of the detected incident radiation;
calculating the object's three-dimensional directions from each three-dimensional direction detector based on the determined first and second two-dimensional directions; and
calculating the object's distance from each of the three-dimensional direction detectors using triangulation based on the object's determined three-dimensional directions, the object's distance and three dimensional directions determining the object's three-dimensional position.

22. A method of detecting a three-dimensional direction of a radiating object, as per claim 21, wherein the radiating object radiates in the infrared range.

23. A method of detecting a three-dimensional direction of a radiating object, as per claim 21, wherein the radiation is modulated and the modulated radiation is detected.

24. A method of detecting a three-dimensional direction of a radiating object, as per claim 21, wherein the radiating object is one or more LEDs.

25. A method of detecting a three-dimensional direction of a radiating object, as per claim 24, wherein the one or more LEDs are mounted on a glove.

26. A method of detecting a three-dimensional direction of a radiating object, as per claim 24, wherein the radiating object comprises a plurality of LEDs on a device to be worn by a user, the method further comprising determining the three-dimensional position of each LED, and determining the yaw, pitch and roll of a user's associated body part based on the determined three-dimensional position of each LED.

27. A method of detecting a three-dimensional direction of a radiating object, as per claim 26, further comprising determining the yaw, pitch and roll from a rotation matrix calculated based on the three-dimensional positions of three out of the plurality of LEDs.
